(19) United States
(12) Patent Application Publication
(10) Pub. No.: US 2019/0131085 A1
(43) Pub. Date: May 2, 2019

(54) KEYSWITCH

(71) Applicant: DARFON ELECTRONICS CORP., Taoyuan City (TW)

(72) Inventors: Sung-Fu Yang, Taoyuan City (TW); Po-Chun Hou, Taoyuan City (TW)

(21) Appl. No.: 16/175,803

(22) Filed: Oct. 30, 2018

(30) Foreign Application Priority Data
Oct. 31, 2017 (TW) 106137485

(51) Int. Cl. H01H 13/14; H01H 13/20; H01H 13/52

(52) U.S. Cl. CPC H01H 13/14; H01H 2221/04; H01H 13/52; H01H 13/20

(57) ABSTRACT

A keyswitch includes a board, a cap, a lifting mechanism, a returning device, first and second blocks. The lifting mechanism is disposed between the board and the cap and includes first and second plates pivoted to the board and opposite to each other. The returning device is located between the first and second plates and includes first and second magnetic members. The first magnetic member extends from the first plate corresponding to the second magnetic member disposed on the board. An abutting part extends from the second plate and abuts under the first magnetic member. The first and second blocks are formed on the cap and respectively spaced from the first and second plates. When the first and second plates are pressed to deform, the first and second blocks abut against the first and second plates respectively to keep the abutting part located under the first magnetic member.

### BACKGROUND OF THE INVENTION

### 1. Field of the Invention

The present invention relates to a keyswitch, and more specifically, to a keyswitch utilizing blocks formed on a cap or plates of a lifting mechanism to block deformation of the plates.

### 2. Description of the Prior Art

A keyboard, which is the most common input device, could be found in variety of electronic apparatuses for users to input characters, symbols, numerals and so on. Furthermore, from consumer electronic products to industrial machine tools, they are all equipped with a keyboard for performing input operations.

A conventional keyswitch usually adopts the design that an elastic member is disposed between a cap and a board. In such a manner, after the cap is pressed, the elastic member could provide elastic force to drive the cap back to its original position via linkage of a lifting mechanism (e.g. a scissor support mechanism). Because the elastic member is usually made of rubber material, elastic fatigue of the elastic member may occur after the elastic member is used over a long period of time so as to shorten the life of the keyswitch.

In general, a magnetic attraction design can be utilized to solve the aforesaid problem. For example, the keyswitch could adopt the design that the lifting mechanism is composed of two plates pivoted to the board and opposite to each other. In this design, one plate has a magnetic member disposed thereon and the other plate has an abutting part to abut under the magnetic member for generating the plate linkage effect, and the other magnetic member is disposed on the board. Accordingly, when the cap is pressed by an external force, the two plates are pivoted relative to the board to raise the abutting part to drive the magnetic member on the plate away from the magnetic member on the board. When the external force is released, a magnetic attraction force between the two magnetic members drives the two magnetic members to approach each other, so as to move the cap back to its original position for generating the automatic returning effect.

However, since deformation of the two plates usually occurs when a user exerts excessive pressing force on the cap, it may dislocate the abutting part to be located above the magnetic member on the plate, which causes failure of linkage between the two plates or structural jamming of the two plates. Thus, operational stability of the keyswitch is influenced greatly.

### SUMMARY OF THE INVENTION

The present invention provides a keyswitch including a board, a cap, a lifting mechanism, a returning device, a first plate, and a second plate. The cap has a long axis. The lifting mechanism is disposed between the board and the cap. The cap is movable between a pressed position and a non-pressed position relative to the board via the lifting mechanism. The lifting mechanism includes a first plate and a second plate. The first and second plates are opposite to each other. The first plate is pivotably connected to the board and abuts against the cap. The first plate has a first middle section and a first tail section. The second plate has a second middle section and a second tail section. The first middle section and the second middle section are adjacent to a center point of the long axis. The first tail section and the second tail section are adjacent to a terminal point of the long axis. The returning device is located between the first plate and the second plate. The returning device includes a first magnetic member and a second magnetic member. The first magnetic member extends from the first middle section toward the second plate. The second magnetic member is disposed on the board corresponding to the first magnetic member. An abutting part extends from the second middle section toward the first plate to abut under the first magnetic member. The first block is formed on one of the cap and the first tail section to be spaced from the other one of the cap and the first tail section. The second block is formed on one of the cap and the second tail section to be spaced from the other one of the cap and the second tail section. When the cap is pressed to deform the first plate and the second plate, the first tail section and the second tail section slide relative to the cap to a position where the other one of the cap and the first tail section abuts against the first block and the other one of the cap and the second tail section abuts against the second block, for limiting the abutting part to be located under the first magnetic member when the cap is released. When the cap is not pressed, a magnetic attraction force between the first magnetic member and the second magnetic member keeps the cap at the non-pressed position. When the cap is pressed to move the first magnetic member away from the second magnetic member with pivoting of the first plate relative to the board and tilt the abutting part, the cap moves from the non-pressed position to the pressed position together with the lifting mechanism. When the cap is released, the magnetic attraction force drives the first magnetic member to approach the second magnetic member to move the cap from the pressed position back to the non-pressed position together with the lifting mechanism.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a keyswitch according to an embodiment of the present invention.

FIG. 2 is a cross-sectional diagram of the keyswitch in FIG. 1 along a cross-sectional line A-A.

FIG. 3 is a cross-sectional diagram of a cap in FIG. 2 being pressed to a pressed position.

FIG. 4 is an enlarged diagram of the cap in FIG. 1 from another viewing angle.

FIG. 5 is an enlarged diagram of a first plate and a second plate in FIG. 1 from another viewing angle.

FIG. 6 is a cross-sectional diagram of the keyswitch in FIG. 1 along a cross-sectional line B-B.

FIG. 7 is a cross-sectional diagram of the cap in FIG. 6 being pressed to the pressed position.

### DETAILED DESCRIPTION

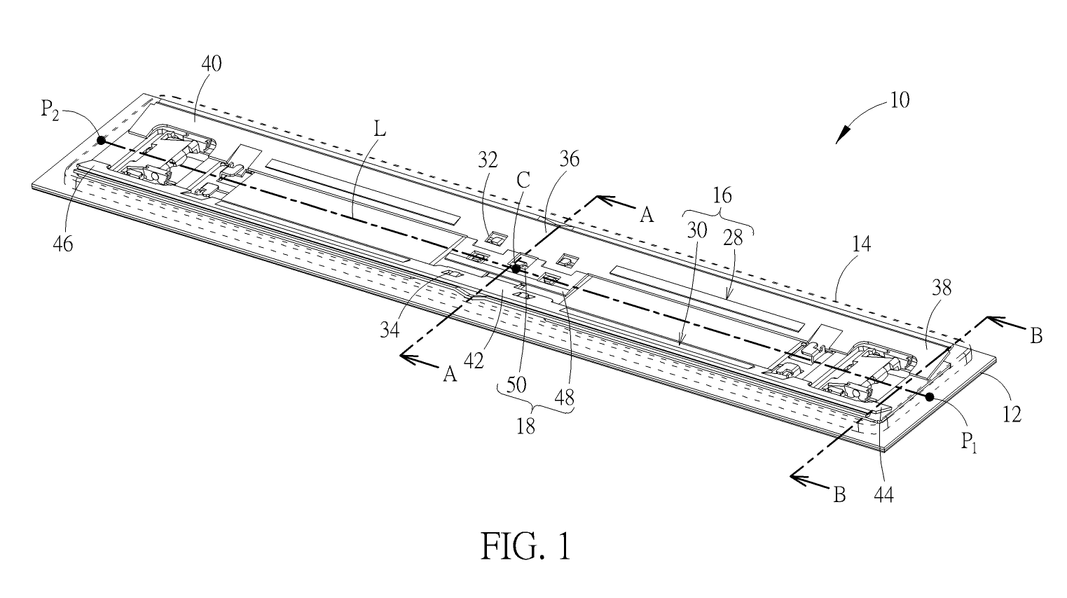

Please refer to FIG. 1, which is a diagram of a keyswitch 10 according to an embodiment of the present invention. For clearly showing the internal mechanical design of the keyswitch 10, a cap 14 is briefly depicted by dotted lines in FIG. 1. As shown in FIG. 1, the keyswitch 10 is preferably a long keyswitch (also called as a multiple-width keyswitch), but not limited thereto. The keyswitch 10 includes a board 12, the cap 14, a lifting mechanism 16, a returning device 18, a first block 20, a second block 22, a third block 24, and a fourth block 26. The cap 14 has a long axis L. The lifting mechanism 16 is disposed between the board 12 and the cap 14 such that the cap 14 can move upward and downward between a pressed position and a pressed position relative to the board 12 via the lifting mechanism 16. The lifting mechanism 16 includes a first plate 28 and a second plate 30. The first plate 28 and the second plate 30 are opposite to each other and abut against the cap 14. The first plate 28 has at least one first containing opening 32 (five shown in FIG. 1, but not limited thereto). The board 12 partially enters the first containing opening 32 to make the first plate 28 pivotably connected to the board 12. The aforesaid containing opening design could also be applied to the second plate 30 (but not limited thereto). That is to say, the second plate 30 has at least one second containing opening 34 (two shown in FIG. 1, but not limited thereto). The board 12 partially enters the second containing opening 34 to make the second plate 30 pivotably connected to the board 12. To be more specific, the first plate 28 has a first middle section 36, a first tail section 38 and a third tail section 40, and the second plate 30 has a second middle section 42, a second tail section 44 and a fourth tail section 46. The first middle section 36 and the second middle section 42 are adjacent to a center point C of the long axis L. The first tail section 38 and the second tail section 44 are adjacent to a terminal end P₁ of the long axis L, and the third tail section 40 and the fourth tail section 46 are adjacent to a terminal end P₂ of the long axis L.

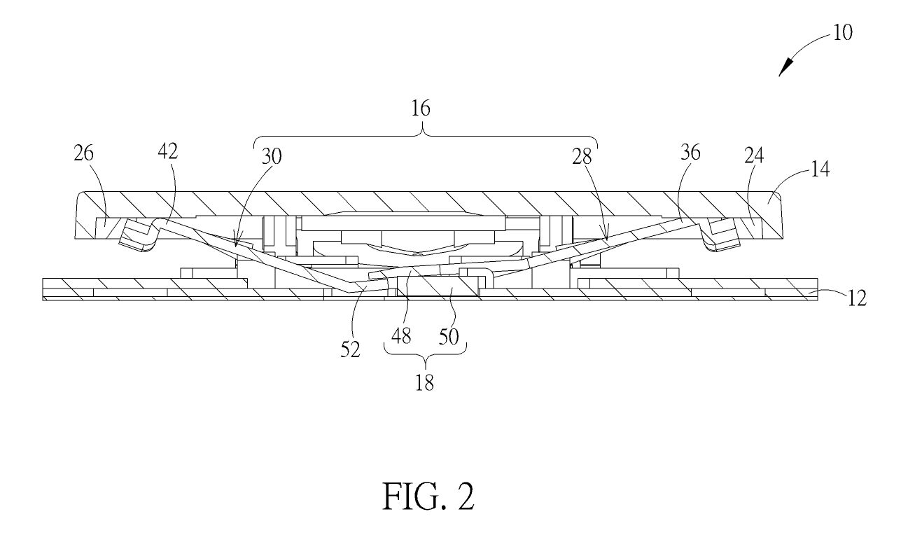

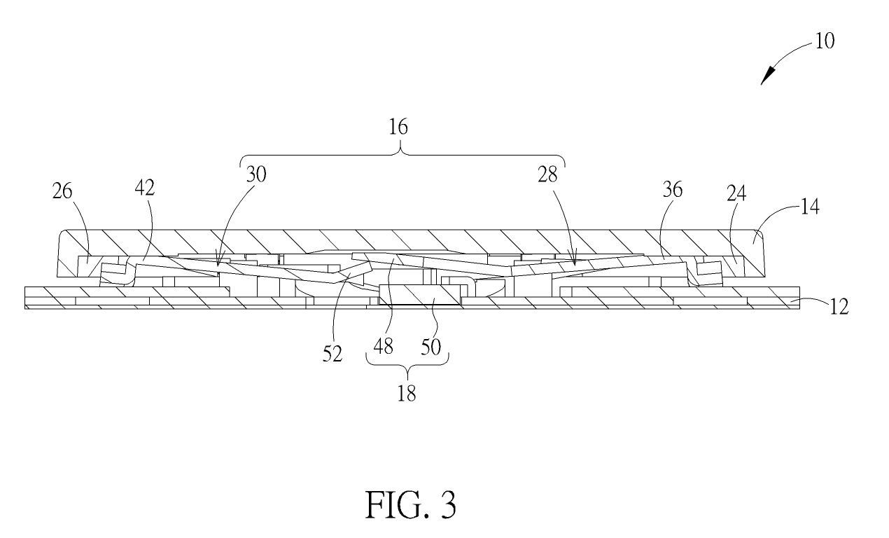

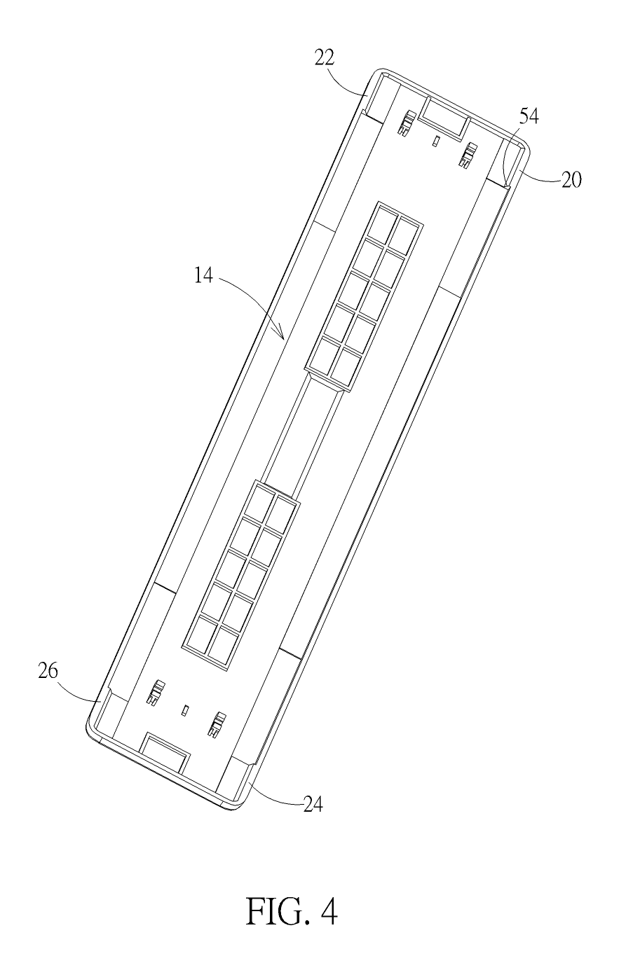

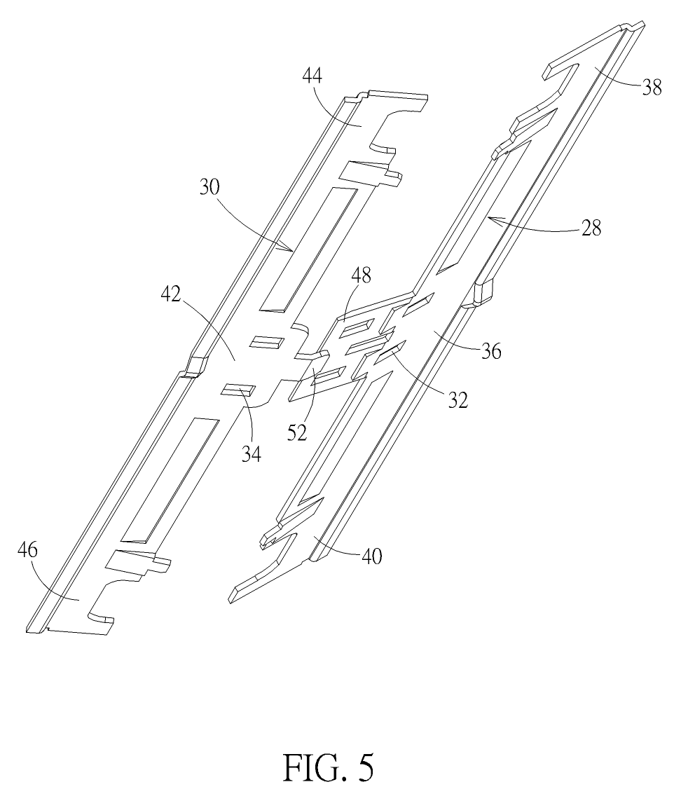

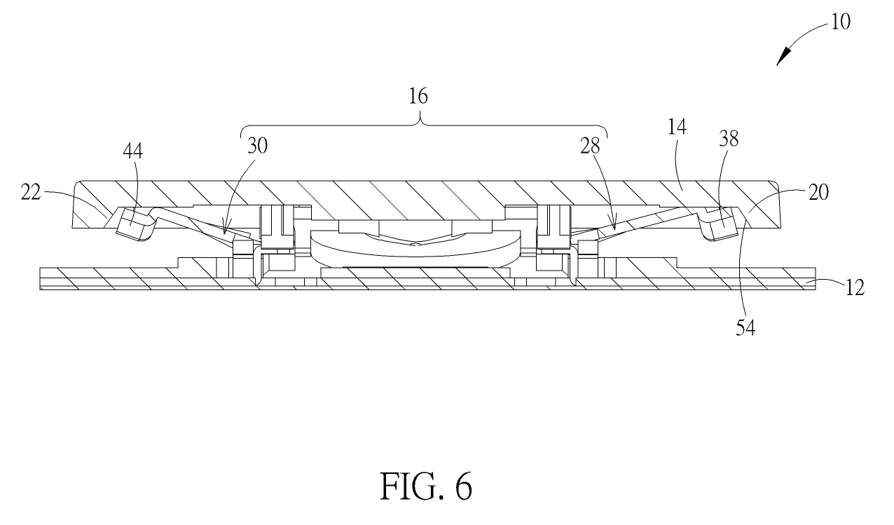

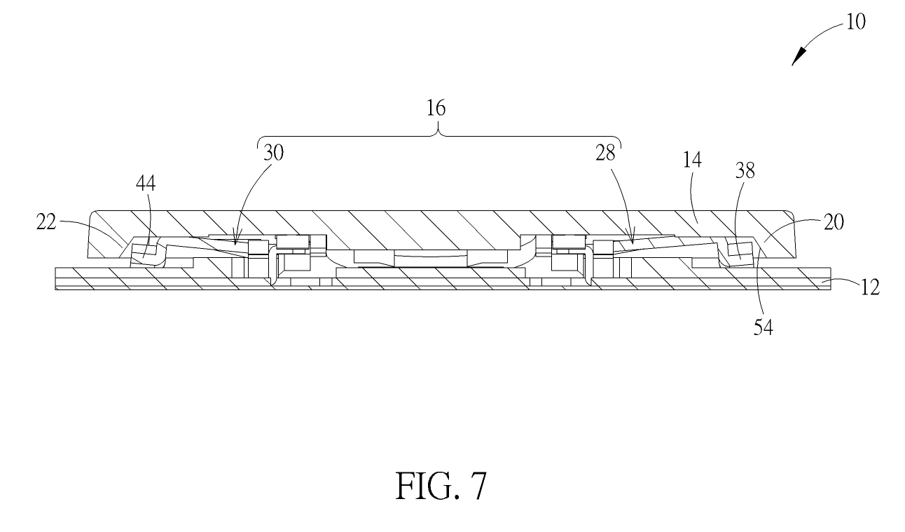

Please refer to FIG. 2, FIG. 3, FIG. 4, FIG. 5, FIG. 6 and FIG. 7. FIG. 2 is a cross-sectional diagram of the keyswitch 10 in FIG. 1 along a cross-sectional line A-A. FIG. 3 is a cross-sectional diagram of the cap 14 in FIG. 2 being pressed to the pressed position. FIG. 4 is an enlarged diagram of the cap 14 in FIG. 1 from another viewing angle. FIG. 5 is an enlarged diagram of the first plate 28 and the second plate 30 in FIG. 1 from another viewing angle. FIG. 6 is a cross-sectional diagram of the keyswitch 10 in FIG. 1 along a cross-sectional line B-B. FIG. 7 is a cross-sectional diagram of the cap 14 in FIG. 6 being pressed to the pressed position. As shown in FIGS. 2-7, the returning device 18 is located between the first plate 28 and the second plate 30 and includes a first magnetic member 48 and a second magnetic member 50. The first magnetic member 48 extends from the first plate 28 toward the second plate 30, and the second magnetic member 50 is disposed on the board 12 corresponding to the first magnetic member 48. The second plate 30 has an abutting part 52. The abutting part 52 extends from the second middle section 42 toward the first plate 28 to abut under the first magnetic member 48 (as shown in FIG. 5). Accordingly, the first magnetic member 48 can magnetically attracts the second magnetic member 50 to generate a returning force.

In this embodiment, the first block 20 and the second block 22 are preferably formed on the cap 14 and are spaced from the first tail section 38 and the second tail section 44 respectively, and the third block 24 and the fourth block 26 are preferably formed on the cap 14 and are spaced from the third tail section 40 and the fourth tail section 46 respectively. The first block 20 could be preferably in a wedge shape (but not limited thereto) and could be a stripe-shaped block structure continuously formed on the cap 14 (as shown in FIG. 4, but not limited thereto, meaning that the first block 20 could be a multi-segment block structure discontinuously formed on the cap 14 in another embodiment). The first block 20, the second block 22, the third block 24, and the fourth block 26 are identical block structures and are symmetrical to each other. To be more specific, for surely preventing the first block 20 from interfering with the first plate 28 in the condition that the first plate 28 does not deform, a slope structure 54 is formed on the first block 20 and is opposite to the first tail section 38. In such a manner, the present invention can keep the first block 20 spaced from the first tail section 38 of the first plate 28 at the same distance when the first plate 28 is pivoted relative to the board 12 (as shown in FIGS. 6-7). The aforesaid slope structural design could also be applied to the second block 22, the third block 24, and the fourth block 26, and the related description could be reasoned by analogy according to the aforesaid description and omitted herein.

Via the aforesaid designs, when the cap 14 is not pressed, the first magnetic member 48 magnetically attracts the second magnetic member 50 to keep the cap 14 at the non-pressed position as shown in FIG. 2. When the cap 14 is pressed by an external force to pivot the first plate 28 and the second plate 30 relative to the board 12 and tilt the abutting part 52 for moving the first magnetic member 48 of the first plate 28 away from the second magnetic member 50 on the board 12, the cap 14 moves from the non-pressed position as shown in FIG. 2 to the pressed position as shown in FIG. 3 together with the lifting mechanism 16 for executing a corresponding input function. When the external force is released, a magnetic attraction force between the first magnetic member 48 and the second magnetic member 50 drives the first magnetic member 48 to approach and then be magnetically attached to the second magnetic member 50, so as to move the cap 14 from the pressed-position as shown in FIG. 3 back to the non-pressed position as shown in FIG. 2 for achieving the automatic returning effect.

On the other hand, if deformation of the first plate 28 and the second plate 30 occurs when the user exerts excessive pressing force on the cap 14, the first tail section 38, the second tail section 44, the third tail section 40 and the fourth tail section 46 slide correspondingly relative to the cap 14 to abut against the first block 20, the second block 22, the third block 24 and the fourth block 26 respectively. At this time, via the first block 20 and the third block 24 blocking deformation of the first plate 28 and the second block 22 and the fourth block 26 blocking deformation of the second plate 30, the abutting part 52 can be surely limited to abut under the first magnetic member 50 when the cap 14 is released. In such a manner, the present invention can efficiently solve the prior art problem that deformation of the plate caused by excessive pressing force dislocates the abutting part to be located above the magnetic member, so as to prevent failure of linkage between the two plates or structural jamming of the two plates for greatly improving operational stability of the keyswitch.

It should be mentioned that the block forming position is not limited to the aforesaid embodiment, which means the present invention could adopt the design that the block is directly formed on the plate in another embodiment. In brief, in another embodiment, the blocks could be formed on the tail sections of the two plates respectively and could be spaced from the cap. In such a manner, if the cap is pressed to cause deformation of the two plates, the tail sections of the two plates slide relative to the cap to make the blocks abut against the cap, so as to generate the same limiting effect as mentioned by the aforesaid embodiment. As for the detailed description for this embodiment and other derived embodiments (e.g. the embodiment that the first and third blocks are formed on the cap and the second and fourth blocks are formed on the second and fourth tail sections of the second plate respectively), it could be reasoned by analogy according to the aforesaid description and omitted herein. In addition, the third block and the fourth block are omissible components, meaning that the present invention could adopt the design in which there are only the first block and the second block formed on the cap to block deformation of the first and second plates for simplifying the structural design of the keyswitch.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch comprising:
a board;
a cap having a long axis;
a lifting mechanism disposed between the board and the cap, the cap being movable between a pressed position and a non-pressed position relative to the board via the lifting mechanism, the lifting mechanism comprising a first plate and a second plate, the first and second plates being opposite to each other, the first plate being pivotably connected to the board and abutting against the cap, the first plate having a first middle section and a first tail section, the second plate having a second middle section and a second tail section, the first middle section and the second middle section being adjacent to a center point of the long axis, the first tail section and the second tail section being adjacent to a terminal point of the long axis;
a returning device located between the first plate and the second plate, the returning device comprising a first magnetic member and a second magnetic member, the first magnetic member extending from the first middle section toward the second plate, the second magnetic member being disposed on the board corresponding to the first magnetic member, an abutting part extending from the second middle section toward the first plate to abut under the first magnetic member;
a first block formed on one of the cap and the first tail section to be spaced from the other one of the cap and the first tail section; and
a second block formed on one of the cap and the second tail section to be spaced from the other one of the cap and the second tail section;
wherein when the cap is pressed to deform the first plate and the second plate, the first tail section and the second tail section slide relative to the cap to a position where the other one of the cap and the first tail section abuts against the first block and the other one of the cap and the second tail section abuts against the second block, for limiting the abutting part to be located under the first magnetic member when the cap is released;
when the cap is not pressed, a magnetic attraction force between the first magnetic member and the second magnetic member keeps the cap at the non-pressed position;
when the cap is pressed to move the first magnetic member away from the second magnetic member with pivoting of the first plate relative to the board and tilt the abutting part, the cap moves from the non-pressed position to the pressed position together with the lifting mechanism;
when the cap is released, the magnetic attraction force drives the first magnetic member to approach the second magnetic member to move the cap from the pressed position back to the non-pressed position together with the lifting mechanism.

2. The keyswitch of claim 1, wherein a slope structure is formed on the first block and is opposite to the other one of the cap and the first tail section, to keep the first block spaced from the other one of the cap and the first tail section at the same distance when the first plate is pivoted relative to the board and does not deform.

3. The keyswitch of claim 2, wherein the first block is in a wedge shape.

4. The keyswitch of claim 2, wherein the first block and the second block are identical and symmetrical block structures.

5. The keyswitch of claim 1, wherein the first plate further has a third tail section, the second plate further has a fourth tail section, the third tail section and the fourth tail section are adjacent to the other terminal end of the long axis, and the keyswitch further comprises:
a third block formed on one of the cap and the third tail section to be spaced from the other one of the cap and the third tail section; and
a fourth block formed on one of the cap and the fourth tail section to be spaced from the other one of the cap and the fourth tail section;
wherein when the cap is pressed to deform the first plate and the second plate, the third tail section and the fourth tail section slide relative to the cap to a position where the other one of the cap and the third tail section abuts against the third block and the other one of the cap and the fourth tail section abuts against the fourth block, for limiting the abutting part to be located under the first magnetic member when the cap is released.

6. The keyswitch of claim 5, wherein a slope structure is formed on the first block and is opposite to the other one of the cap and the first tail section, to keep the first block spaced from the other one of the cap and the first tail section at the same distance when the first plate is pivoted relative to the board and does not deform.

7. The keyswitch of claim 6, wherein the first block is in a wedge shape.

8. The keyswitch of claim 6, wherein the first block, the second block, the third block and the fourth block are identical and symmetrical block structures.

9. The keyswitch of claim 1, wherein the first plate further has at least one containing opening, and the board partially enters the at least one containing opening to make the first plate pivotably connected to the board.
